(19) United States
(12) Patent Application Publication
(10) Pub. No.: US 2018/0012301 A1
(43) Pub. Date: Jan. 11, 2018

(54) BLOCK-PRICE OPTIMISATION IN ENERGY MARKETS

(71) Applicant: INTERNATIONAL BUSINESS MACHINES CORPORATION, ARMONK, NY (US)

(72) Inventors: HARISH BHARTI, PUNE (IN); ABHAY K. PATRA, PUNE (IN); RAJESH K. SAXENA, PUNE (IN)

(21) Appl. No.: 15/204,321

(22) Filed: Jul. 7, 2016

(51) Int. Cl. G06Q 40/04; G06Q 50/06

(52) U.S. Cl. CPC G06Q 40/04; G06Q 50/06

(57) ABSTRACT

Aspects optimize competitive bidding processes for energy suppliers as a function of energy block denominations. Subset energy block sizes are defined with different quantities of energy that total up to a specified quantity of energy, as a function of matching block sizes to bidding size preferences indicated by prior supplier bidding activities of different energy suppliers. Likely dispersion distributions of bids of offered energy by the energy suppliers are determined across each of the different energy block sizes as a function of likelihoods to bid for each of the energy block sizes at the specified price. A subset group of the energy blocks are identified that have likely dispersion distribution values less than a threshold dispersion value. Energy bids are allocated to the suppliers according to their likelihood to bid in the energy quantities of the subset of the energy blocks.

### BACKGROUND

Embodiments of the present invention relate to energy purchasing, and more particularly to systems, process and methods for optimizing energy purchase decisions.

Utilities and other energy provider services may attempt to minimize pricing opportunity gaps between valuations defined by demand and supply by adapting traditional demand-side management processes. Rather than relying entirely or solely on current or spot-market pricing at the time of purchase, utilities may hedge against pricing and demand fluctuations by buying energy from market sources through pre-defined pricing structures within supplier contracts, and often may use both methods in combination.

### BRIEF SUMMARY

In one aspect of the present invention, a computerized method for optimizing competitive bidding processes for energy suppliers as a function of energy block denominations executes steps on a computer processor. Thus, a plurality of different energy suppliers are identified as available to bid for supplying some or all of a specified quantity of energy at a specified price. A plurality of subset energy block sizes are defined with different quantities of energy that total up to the specified quantity of energy, as a function of matching at least one of the block sizes to a bidding size preference indicated by prior supplier bidding activities of at least one of the different energy suppliers. Likely dispersion distributions of bids of offered energy by the different energy suppliers are determined across each of the different energy block sizes as a function of likelihoods to bid for each of the energy block sizes at the specified price. A subset of the energy blocks are identified that each have likely dispersion distribution values that are less than a threshold dispersion value. Energy bids are allocated to the suppliers according to their likelihood to bid in the energy quantities of the subset of the energy blocks.

In another aspect, a system has a hardware processor in circuit communication with a computer readable memory and a computer-readable storage medium having program instructions stored thereon. The processor executes the program instructions stored on the computer-readable storage medium via the computer readable memory and thereby identifies a plurality of different energy suppliers as available to bid for supplying some or all of a specified quantity of energy at a specified price. A plurality of subset energy block sizes are defined with different quantities of energy that total up to the specified quantity of energy, as a function of matching at least one of the block sizes to a bidding size preference indicated by prior supplier bidding activities of at least one of the different energy suppliers. Likely dispersion distributions of bids of offered energy by the different energy suppliers are determined across each of the different energy block sizes as a function of likelihoods to bid for each of the energy block sizes at the specified price. A subset of the energy blocks are identified that each have likely dispersion distribution values that are less than a threshold dispersion value. Energy bids are allocated to the suppliers according to their likelihood to bid in the energy quantities of the subset of the energy blocks.

In another aspect, a computer program product for optimizing competitive bidding processes for energy suppliers as a function of energy block denominations has a computer-readable storage medium with computer readable program code embodied therewith. The computer readable hardware medium is not a transitory signal per se. The computer readable program code includes instructions for execution which cause the processor to identify a plurality of different energy suppliers as available to bid for supplying some or all of a specified quantity of energy at a specified price. A plurality of subset energy block sizes are defined with different quantities of energy that total up to the specified quantity of energy, as a function of matching at least one of the block sizes to a bidding size preference indicated by prior supplier bidding activities of at least one of the different energy suppliers. Likely dispersion distributions of bids of offered energy by the different energy suppliers are determined across each of the different energy block sizes as a function of likelihoods to bid for each of the energy block sizes at the specified price. A subset of the energy blocks are identified that each have likely dispersion distribution values that are less than a threshold dispersion value. Energy bids are allocated to the suppliers according to their likelihood to bid in the energy quantities of the subset of the energy blocks.

### BRIEF DESCRIPTION OF THE DRAWINGS

These and other features of embodiments of the present invention will be more readily understood from the following detailed description of the various aspects of the invention taken in conjunction with the accompanying drawings in which:

FIG. 1 depicts a cloud computing environment according to an embodiment of the present invention.

FIG. 2 depicts a cloud computing node according to an embodiment of the present invention.

FIG. 3 depicts a computerized aspect according to an embodiment of the present invention.

FIG. 4 is a flow chart illustration of a process or system for optimizing competitive bidding processes for energy suppliers as a function of energy block denominations according to an embodiment of the present invention.

FIG. 5 is a flow chart illustration of another embodiment of the present invention that optimizes competitive bidding processes for energy suppliers as a function of energy block denominations.

FIG. 6 is a flow chart illustration of another embodiment of the present invention that optimizes competitive bidding processes for energy suppliers as a function of energy block denominations.

FIG. 7 is graphic illustration of a relationship of supplier confidence scores to bid prices as determined by an aspect of the present invention.

FIG. 8 is a tabular illustration of data associated with supplier bidding according to an aspect of the present invention.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

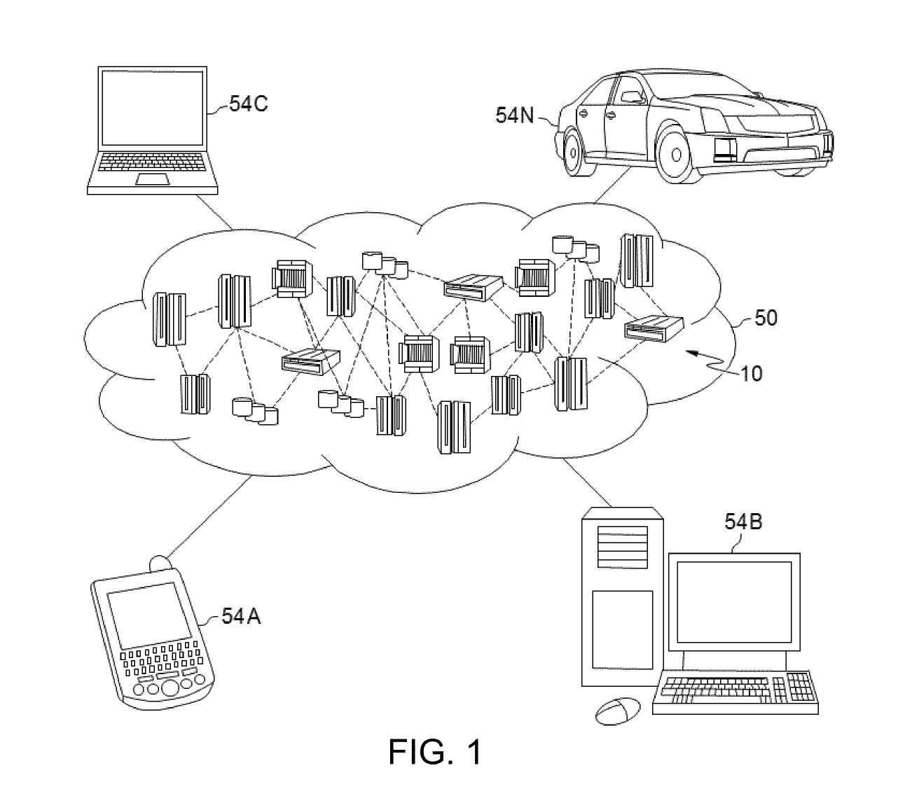

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

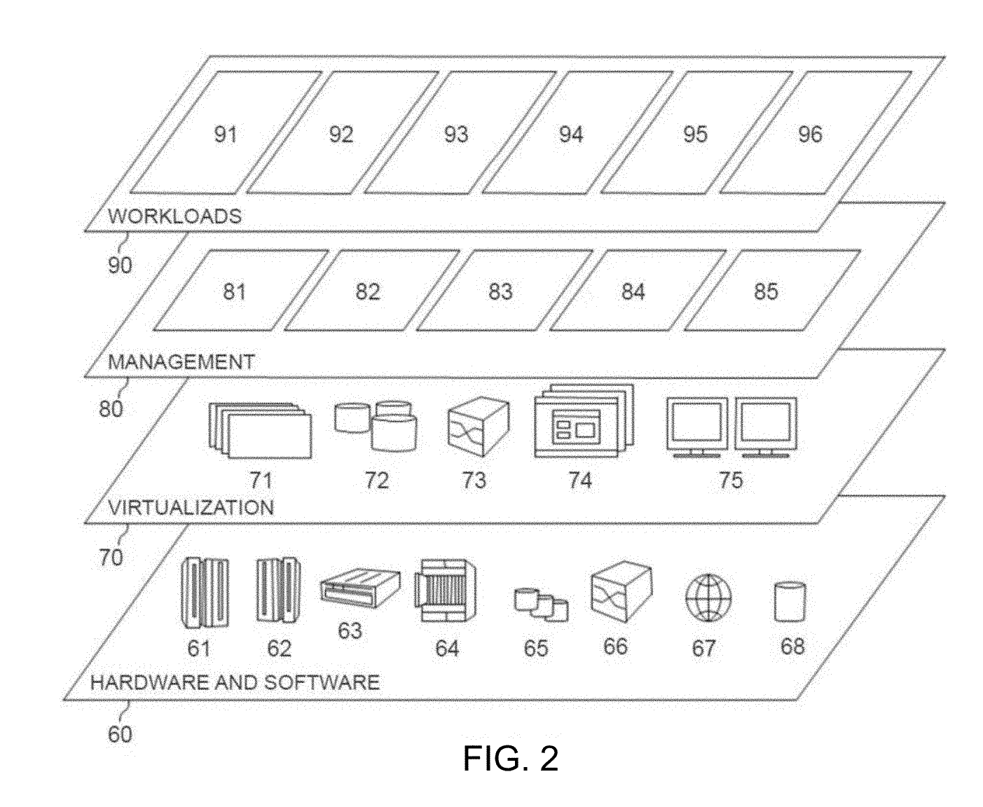

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components.

Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below.

Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

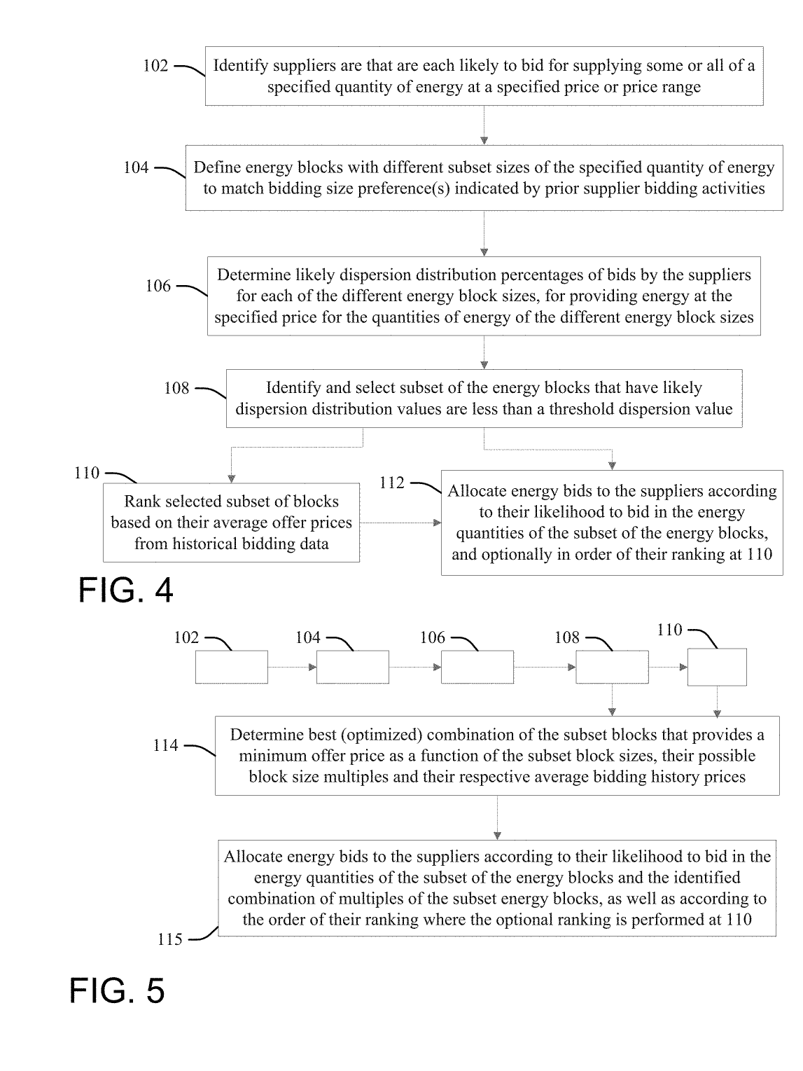

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing 96 according to embodiments of the present invention, for example to execute the process steps or system components or tasks as depicted in FIG. 4 below.

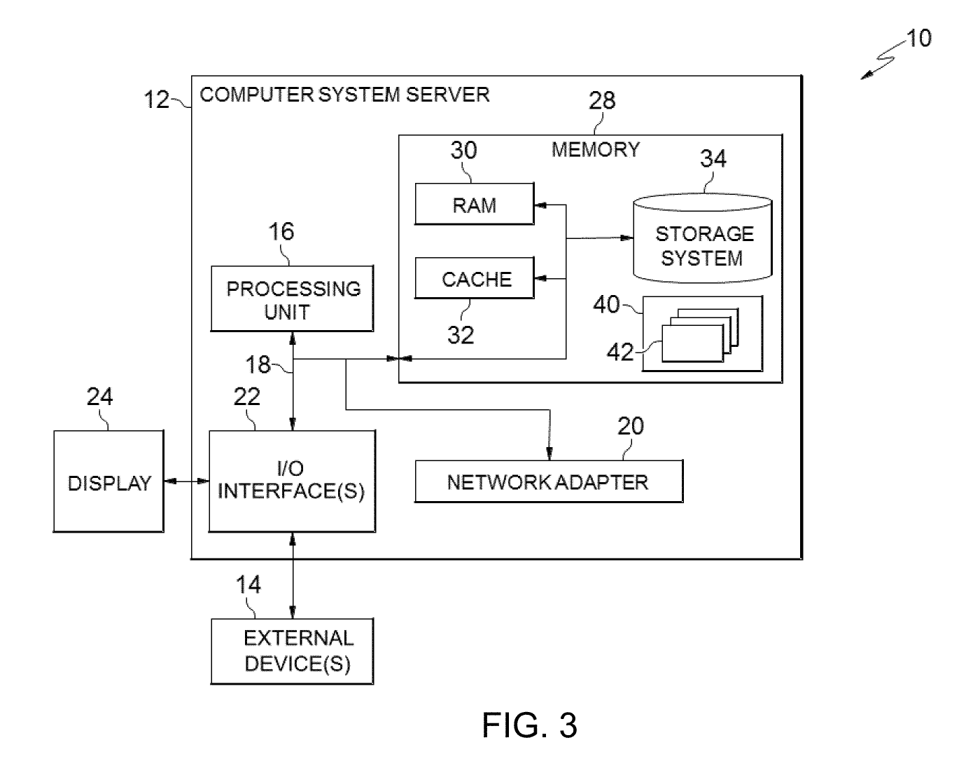

FIG. 3 is a schematic of an example of a programmable device implementation 10 according to an aspect of the present invention, which may function as a cloud computing node within the cloud computing environment of FIG. 2. Programmable device implementation 10 is only one example of a suitable implementation and is not intended to suggest any limitation as to the scope of use or functionality of embodiments of the invention described herein. Regardless, programmable device implementation 10 is capable of being implemented and/or performing any of the functionality set forth hereinabove.

A computer system/server 12 is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

The computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

FIG. 4 illustrates a process or system according to the present invention for optimizing competitive bidding processes for energy suppliers as a function of energy block denominations. At 102 a plurality of different suppliers are identified that are each likely to bid for supplying some or all of a specified quantity of energy at a specified price or price range.

At 104 a plurality of energy blocks are defined with different subset sizes of the specified quantity of energy, in order to match one or more of the block sizes to bidding size preferences indicated by prior supplier bidding activities.

At 106 a likely dispersion distribution of bids by the available suppliers is determined for each of the different energy block sizes. The dispersion distributions are a percentage of the available suppliers (identified at 102) that are likely to bid for providing energy at the specified price (or within the specified price range) for the quantities of energy of the different energy block sizes.

At 108 a subset of the different energy blocks is identified and selected that each have likely dispersion distribution values that are less than a threshold dispersion value. More particularly, the threshold dispersion value is chosen to identify block sizes that will generate the best response from the supplier network, wherein blocks having lessor dispersion values relative to other blocks (and below the threshold) will generate the most competitive offered pricing for the block size. The threshold is determined from historic bidding data, to define a threshold dispersion statistic useful as a hurdle to select the blocks with favorable (least) dispersion values at the specified boundary price/price range, wherein the suppliers are more likely to bid at pricing closer to the desired target or strike pricing, rather than quote higher pricing.

At 110 the selected subset of blocks (that have dispersion values less than the threshold value) may be ranked (sorted in ascending order) based on average offer prices determined for each of the different blocks from historic bidding data.

At 112 the energy bids are allocated to the suppliers according to their likelihood to bid in the energy quantities of the subset of the energy blocks, in order of their ranking where the optional ranking step or process is performed at 110.

FIG. 5 illustrates an alternative embodiment of the present invention, wherein the process or system of FIG. 4 further includes a step or process at 114 of determining a best (optimized) combination of the subset blocks that provides a minimum offer price as a function of the subset block sizes, their possible block size multiples and their respective average bidding history prices. More particularly, the combination of multiples of the subset energy blocks is likely to provide a minimum offer price as a function of the combination subset block sizes and their respective average bidding history prices. In this embodiment, energy bids are allocated to the suppliers at 115 according to their likelihood to bid in the energy quantities of the subset of the energy blocks and the identified combination of multiples of the subset energy blocks, as well as according to the order of their ranking where the optional ranking step or process is performed at 110.

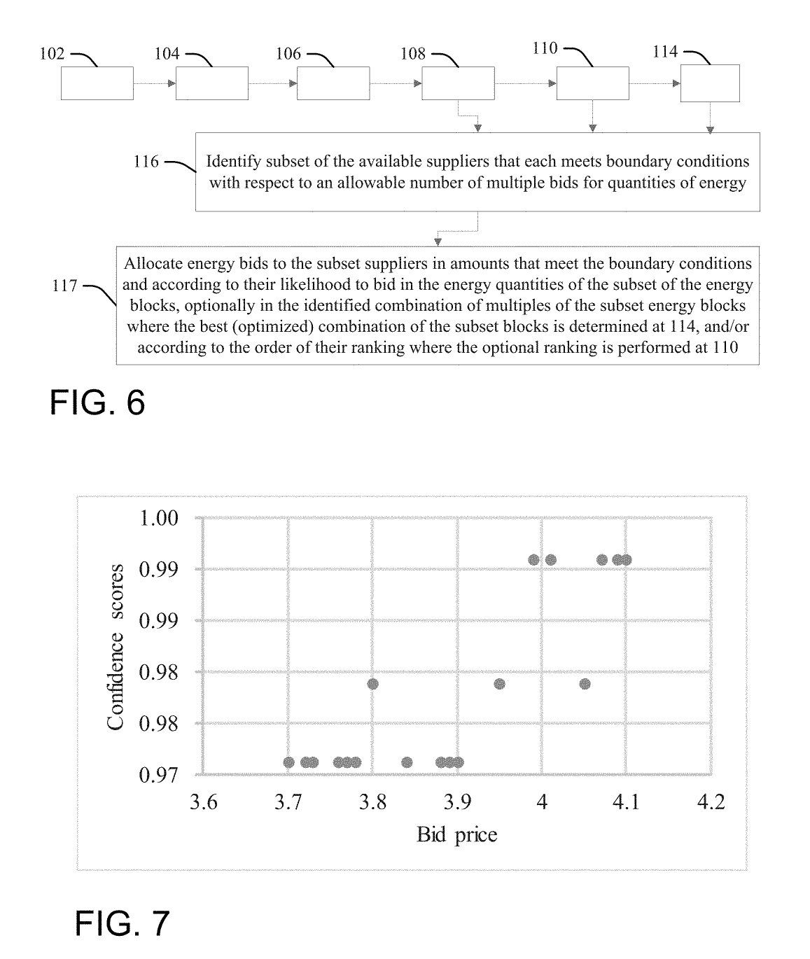

FIG. 6 illustrates an alternative embodiment of the present invention, wherein the process or system of FIG. 4 (or of FIG. 5) further includes a step or process at 116 of identifying a subset of the available suppliers that each meets boundary conditions with respect to an allowable number of multiple bids for quantities of energy. More particularly, a supplier can be awarded only one block size but allowed multiples for the awarded block size, wherein a total of the block sizes for the supplier may also have to comply with optimized combination values (as determined at 114 of the embodiment of FIG. 5). Satisfaction of the boundary conditions include where the block sizes add up to an acceptable energy gap value (wherein the total is less than the target quantity), or otherwise remain below a required level (for example, as defined by optimized combination values determined at 114 of FIG. 5). In these aspects, the step or process of allocating the energy bids to the suppliers at 117 allocates the bids to the subset suppliers in amounts that meet the boundary conditions and according to their likelihood to bid in the energy quantities of the subset of the energy blocks, as well as optionally in the identified combination of multiples of the subset energy blocks where the best (optimized) combination of the subset blocks that provides a minimum offer price is determined at 114, and/or according to the order of their ranking where the optional ranking step or process is performed at 110.

Aspects of the present invention provide comprehensive frameworks that enable the optimization of energy block denominations and block pricing to ensure a competitive bidding process and successful participation from a supplier network, in some embodiments with respective supplier confidence scores for the respective energy blocks.

In one example, for a universal set of the suppliers designated as {S}, a subset {n} of the suppliers {Sₙ} is identified (at 102) as available in the market for a bid participation program for given market conditions (the specified quantity of energy and price/price range, weather conditions, current and/or projected commodity pricing, etc.), according to the expression or equation (“Eq.”) (1):

{Sₙ}ε{S};∀Sₙ→[S_{availability}=1] Eq. (1)

Determining the energy block denominations available for purchase operations (at 104) identifies what energy block sizes will be best to work with as a function of the supplier's preferences to buy. In some examples, this is determined by sensitizing a supplier database with blocks sold per a bid tendering policy and observing the actual and predicted responses of such offers, wherein the blocks that show most competitive response are the ones retained and used. Generally, the competitiveness of an energy block will depend on how many suppliers are ready to participate by bidding.

In one example, the likely supplier population dispersion distribution percentages are designated by {σₚₒₚᵤₗₐₜᵢₒₙ} and determined (at 106) as a function of the selection of the suppliers {Sₙ} according to equation (2):

$${σ}_{population} = \frac{1}{{S}_{n} - 1} {\sum }_{i = 1}^{{S}_{n}} {( {S}_{SCS} - \overline{s} )}^{2} \qquad Eq . ( 2 )$$

Where {S_{SCS}} is a “supplier confidence score” for the considered block size, and {s̅} is an average supplier confidence score. We can infer from the {σₚₒₚᵤₗₐₜᵢₒₙ} value whether the anticipated average price for the block offer is attractive for market making, or if it instead needs to be revised. We can consider each of the energy blocks {k} as a strata. If we define a set {B} such that it is a collection of all block denominations defined under a bid tendering policy, then {Bₖ} may designate a set of all available energy block denominations depending on the blocks allowed for trade under the bid tendering policy. The number of energy blocks {k} may function as a reference counter, and be identified pursuant to expression (3):

kε{1 . . . n};n>0;∀kε{Bₖ} Eq. (3)

The numbers of supplier participants for a given block {nₖ} may be determined as a function of and supplier population dispersion distribution percentages for each block size {k} and established with a confidence {α}, according to equation (4):

$${n}_{k} = \frac{{( {Z}_{∝ / 2} )}^{2} \cdot {σ}_{population}^{2}}{{d}^{2}} \qquad Eq . ( 4 )$$

Where {d} is an allowed deviation from an anticipated price, {a} is a confidence level required for the threshold, and {z∞/2} is a standardized normal value representing said confidence level.

The supplier population dispersion distribution percentage for a given block {σₖ} may be defined by equation (5):

$${σ}_{k} = \frac{1}{{S}_{k} - 1} {\sum }_{i = 1}^{{S}_{k}} {( {S}_{SCS} - \overline{{S}_{k}} )}^{2} \qquad Eq . ( 5 )$$

Where {Sₖ} is a supplier set (for example, as derived in Eq. (1)) that represents all the suppliers who are available to trade for a block of size {k}; {S_{SCS}} is a supplier confidence score for the considered block size {k}; and {s̅ₖ} is the average supplier confidence score for the block size {k}.

Aspects select block sizes that will find a best response from the supplier network, and generally the block sizes {k} having least population dispersion values {σₖ} generate the most competitive offered pricing relative to others of the blocks. Historic data is used to define a threshold dispersion statistic OF {σ_{kthreshold}} for use in selecting blocks with least dispersion {σₖ<σ_{kthreshold}} (at 108).

The supplier confidence score {S_{SCS}} is sensitive to various market conditions and provides a unique score to each supplier based on the inputs. Aspects may identify a set of selected block denominations {B_{c}} that have population dispersion values {σₖ} greater than the threshold {σ_{kthreshold}} for each block size {k} (σₖ≧σ_{threshold}) according to equation (6):

{B_{c}}={B_{c}⊂Bₖ→∀B:∃σₖ≧σ_{threshold}} Eq. (6)

Where {Bₖ} is a set of all the block denominations available as per a current bid-tendering policy.

Some aspects further refine the process of defining the set of selected block denominations {B_{c}} by incorporating a threshold variable {SCS_{threshold}} for the supplier confidence score {S_{SCS}}, for example according to equation (7):

{B_{c}}={B_{c}⊂Bₖ→∀B:∃σₖ≧σ_{threshold};S̅C̅S̅ₖ̅≦SCS_{threshold}} Eq. (7)

Where {Bₖ} is the final selection set of all the block denominations where {S̅C̅S̅ₖ̅≧SCS_{threshold}}.

Aspects identify the average offer price {P(x)} for each block size ‘k’. The average price of all the suppliers for a block {k} may be defined by equation (8):

P(Bₖ)=Σᵢ₌₁^{k}P(Bᵢ)/k Eq. (8)

The set of blocks {Bc} may be rank-sorted (at 110) according to the descending order of the price, as defined by equation (9):

[Bₑ]={∀B:∃P(Bₖ)≧P(Bₖ₋₁)} Eq. (9)

Wherein [B_{c}] is an ordered set, and {Bₖ} is an unordered set.

Aspects may optimize the block size, block size multiples and average price available for a given block size (for example, at 114, FIG. 4) according to the following linear programming expressions:

Optimize: B≦Q₁B₁+Q₂B₂ . . . QⱼBⱼ|B_{1 . . . j}ε[B_{c}]|Qⱼ≦Qⱼ₋₁ Eq. (10)

Where {Q} is a multiples factor for a given block size; and

Minimize: P_{optimized}≦(P₁B₁+P₂B₂ . . . PⱼBⱼ)/Σᵢ₌₁^{j}Pᵢ|B_{1 . . . j}ε[B_{c}]

Such that, (Pₛₜᵣᵢₖₑ−d/2)≦P_{optimized}≦(Pₛₜᵣᵢₖₑ+d/2). Eq. (11)

To identify the appropriate suppliers for bid operations, some aspects impose the following conditions. In one example, a supplier is be allowed to have multiple bids; can be awarded only one block size from said bids, but allowed multiples for the awarded block size; and block sizes may add up to an energy gap or remain below a required level as per an optimization routine. In one example, for each block size suppliers are identified as corresponding to the block size by expression (12):

∀Bₖ::{Sₖ}={S₁ . . . Sᵣ}→∀Sₖ:∃σₖ≧σ_{threshold};S̅C̅S̅ₖ̅≦SCS_{threshold};r≧Qᵢ} (12)

Allocations as per block-price optimization may be derived from the following expression (13):

{B_{1 . . . C},P_{1 . . . k}}=Σⱼ₌₁^{C}Σᵢ₌₁^{Q}^{ⱼ}{Bⱼ}{Pⱼᵢ} Eq. (13)

Where {C} denotes the number of blocks in the collection {B_{c}};{j} is the reference counter indicative of the price for each block being provided by each supplier in {Sₖ}; {Q} is the reference to be multiples for a block size; and {i} is the reference counter indicative of each supplier in {Sₖ}.

The following provides an illustrative but not limiting or exhaustive example of an implementation of an aspect of the present invention. An energy purchaser has a network of 500 suppliers that participate in energy block deal purchases governed by an energy purchase agreement that is revised on a periodic basis. The energy purchaser wishes to purchase 55 megawatts (MWatts) via a bid tendering operation. The current ongoing market price is US$3.90, and the energy purchaser is prepared to book contracts with an allowable difference of 2% in the open market operations, resulting in a specified price range of US$3.82 to US$3.98.

Given the market conditions and a desired strike price of $3.9, 331 of the 500 suppliers are identified as available to bid around the price point (at 102, FIG. 4). A set of block sizes {1, 2, 3, 5, 10, 20 and 50 MWatts} is identified (at 104, FIG. 4) pursuant to a bid-tendering policy.

A standard deviation is used to define the threshold dispersion statistic: {σ_{threshold}=8.9%}. The individual block dispersion values are determined (predicted) for this offer price range for each block denomination based on historic bidding data, resulting in the following dispersion statistic determinations: for block size 1, {σ₁=6.02%}; for block size 3, {σ₃=8.72%}; for block size 10, {σ₁₀=8.86%}; and wherein the dispersion statistic values for each of the other, remaining block sizes all exceed the threshold dispersion statistic value of 8.9%.

The remaining blocks 1, 3 and 10 are then rank-sorted according to their determined average bid prices, with the lower prices ranked higher, resulting in a final rank ordering (at 110) that ranks block size 1 highest {P₁=US$3.80}; block size 3 next {P₃=US$3.95}; and block size 10 last, or lowest {P₁₀=US$4.00}.

The bids are allocated to the rank-ordered blocks so that the total energy purchase will add up to the desired 55 MWatt purchase quantity; so that the blocks with lesser price offerings have more allocations than the blocks with higher price offerings; and so that the total weighted average price is not more that 2% from the target price of US$3.90 (that the weighted average price lies in the range of from US$3.82 to US$3.98). The solution for this combination of constraints may be defined by expression (14):

Optimize: B≦Q₁B₁+Q₂B₂ . . . QⱼBⱼ|B_{1 . . . j}ε[B_{c}]|Qⱼ≦Qⱼ₋₁ Eq. (14)

Where B≦Q₁1+Q₂3+Q₃10, and Q₁≧Q₂≧Q₃

In our present example, this generates an optimized purchase combination of ten bids of block 1, five bids of block 5, and three bids of block 10. This combination produces a total allocation meeting the target of 55 MWatts, with an average price of US$3.952, a deviation of 1.33% from the specified maximum price.

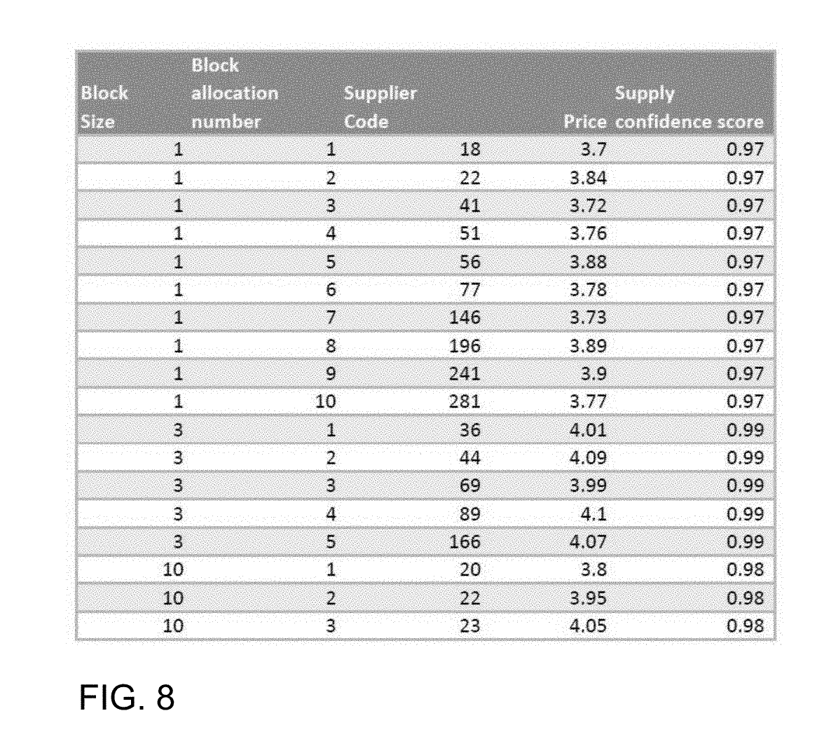

Using the population statistic {SCS_{threshold}} defined above, aspects identify likely suppliers for each of the individual block segments, as plotted in the example graph of FIG. 7. FIG. 8 is a table that shows the resulting expected bids, indicating each block bid by size of block, the number of the block allocation (for example, 1 of 10 of the block 1 size); a supplier code identifying the supplier providing the bid; the price for that bid; and the confidence score in the supplier. The values in FIG. 8 generate an average price of $3.94, placing bids with suppliers having an average confidence score of 98%.

Aspects of the present invention provide comprehensive frameworks that enable the optimization of energy block denominations and block price that enable competitive bidding processes and successful participations from supplier networks as a function of the “supplier confidence score” subject matter defined for respective energy blocks.

Utilities and other energy provider services may attempt to minimize pricing opportunity gaps between valuations defined by demand and supply by adapting traditional demand-side management processes. Rather than relying entirely or solely on current or spot-market pricing at the time of purchase, utilities may hedge against pricing and demand fluctuations by buying energy from market sources through pre-defined pricing structures within supplier contracts, and often may use both methods in combination.

Prior art processes and systems for planning for day-ahead bidding or buying energy at spot price do not take into consideration the block size of the energy requirement, the number of suppliers available for the block sizes, supplier confidence scores for the energy block price and optimum offer prices with a maximum chance of a successful bid determined as a function of the attributes considered by aspects of the present invention. Prior art techniques also fail to consider overall supplier network tendencies and bid distributions based on individual supplier confidence scores according to the present invention in the bidding process.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for optimizing competitive bidding processes for energy suppliers as a function of energy block denominations, comprising executing on a computer processor the steps of:
identifying a plurality of different energy suppliers that are each available to bid for supplying some or all of a specified quantity of energy at a specified price;
defining a plurality of subset energy block sizes of different quantities of energy that total up to the specified quantity of energy, as a function of matching at least one of the block sizes to a bidding size preference indicated by prior supplier bidding activities of at least one of the different energy suppliers;
determining a likely dispersion distribution of bids of offered energy by the different energy suppliers across each of the different energy block sizes as a function of likelihoods to bid for each of the energy block sizes at the specified price;
identifying a subset of the energy blocks that each have likely dispersion distribution values that are less than a threshold dispersion value; and
allocating energy bids to the suppliers according to their likelihood to bid in the energy quantities of the subset of the energy blocks.

2. The method of claim 1, further comprising:
ranking the subset energy blocks as a function of average offer prices determined for each of the different subset energy blocks; and
identifying a combination of multiples of the subset energy blocks that is likely to provide a minimum offer price as a function of the combination subset block sizes and their respective average bidding history prices; and
wherein the step of allocating the energy bids to the suppliers allocates the energy bids according to the identified combination of multiples of the subset energy blocks.

3. The method of claim 1, further comprising:
determining the threshold dispersion value as a function of historic bidding data by at least one of the different energy suppliers.

4. The method of claim 1, further comprising:
determining the threshold dispersion value as a standard deviation value.

5. The method of claim 1, further comprising:
identifying a subset of the different energy suppliers that each meet boundary conditions of an allowable number of multiple bids for the quantity of energy; and
wherein the step of allocating the energy bids to the suppliers allocates the energy bids to the subset suppliers in amounts that meet the boundary conditions.

6. The method of claim 5, wherein the boundary conditions award only one of the block sizes to a supplier from bids of the supplier, and enable the award of multiple bids to the awarded block size to the supplier.

7. The method of claim 1, further comprising:
integrating computer-readable program code into a computer system comprising a processor, a computer readable memory and a computer readable storage medium, wherein the computer readable program code is embodied on the computer readable storage medium and comprises instructions that, when executed by the processor via the computer readable memory, cause the processor to perform the steps of identifying the different energy suppliers available to bid for supplying some or all of the specified quantity of energy at the specified price, defining the plurality of subset energy block sizes, determining the likely dispersion distribution of bids of offered energy by the different energy suppliers across each of the different energy block sizes, identifying the subset of the energy blocks that each have likely dispersion distribution values that are less than a threshold dispersion value, and allocating energy bids to the suppliers according to their likelihood to bid in the energy quantities of the subset of the energy blocks.

8. The method of claim 7, wherein the computer-readable program code is provided as a service in a cloud environment.

9. A system, comprising:
a processor;
a computer readable memory in circuit communication with the processor; and
a computer readable storage medium in circuit communication with the processor;
wherein the processor executes program instructions stored on the computer-readable storage medium via the computer readable memory and thereby:
identifies a plurality of different energy suppliers that are each available to bid for supplying some or all of a specified quantity of energy at a specified price;
defines a plurality of subset energy block sizes of different quantities of energy that total up to the specified quantity of energy, as a function of matching at least one of the block sizes to a bidding size preference indicated by prior supplier bidding activities of at least one of the different energy suppliers;
determine a likely dispersion distribution of bids of offered energy by the different energy suppliers across each of the different energy block sizes as a function of likelihoods to bid for each of the energy block sizes at the specified price;
identifies a subset of the energy blocks that each have likely dispersion distribution values that are less than a threshold dispersion value; and
allocate energy bids to the suppliers according to their likelihood to bid in the energy quantities of the subset of the energy blocks.

10. The system of claim 9, wherein the processor executes program instructions stored on the computer-readable storage medium via the computer readable memory and thereby:
ranks the subset energy blocks as a function of average offer prices determined for each of the different subset energy blocks;
identifies a combination of multiples of the subset energy blocks that is likely to provide a minimum offer price as a function of the combination subset block sizes and their respective average bidding history prices; and
allocates the energy bids according to the identified combination of multiples of the subset energy blocks.

11. The system of claim 9, wherein the processor executes program instructions stored on the computer-readable storage medium via the computer readable memory and thereby determines the threshold dispersion value as a function of historic bidding data by at least one of the different energy suppliers.

12. The system of claim 9, wherein the processor executes program instructions stored on the computer-readable storage medium via the computer readable memory and thereby determines the threshold dispersion value as a standard deviation value.

13. The system of claim 9, wherein the program instructions are provided as a service in a cloud environment.

14. The system of claim 9, wherein the processor executes program instructions stored on the computer-readable storage medium via the computer readable memory and thereby:
identifies a subset of the different energy suppliers that each meet boundary conditions of an allowable number of multiple bids for the quantity of energy; and
allocates the energy bids to the subset suppliers in amounts that meet the boundary conditions.

15. The system of claim 14, wherein the boundary conditions award only one of the block sizes to a supplier from bids of the supplier, and enable the award of multiple bids to the awarded block size to the supplier.

16. A computer program product for optimizing competitive bidding processes for energy suppliers as a function of energy block denominations, the computer program product comprising:
a computer readable storage medium having computer readable program code embodied therewith, wherein the computer readable storage medium is not a transitory signal per se, the computer readable program code comprising instructions for execution by a processor that cause the processor to:
identify a plurality of different energy suppliers that are each available to bid for supplying some or all of a specified quantity of energy at a specified price;
define a plurality of subset energy block sizes of different quantities of energy that total up to the specified quantity of energy, as a function of matching at least one of the block sizes to a bidding size preference indicated by prior supplier bidding activities of at least one of the different energy suppliers;
determine a likely dispersion distribution of bids of offered energy by the different energy suppliers across each of the different energy block sizes as a function of likelihoods to bid for each of the energy block sizes at the specified price;
identify a subset of the energy blocks that each have likely dispersion distribution values that are less than a threshold dispersion value; and
allocate energy bids to the suppliers according to their likelihood to bid in the energy quantities of the subset of the energy blocks.

17. The computer program product of claim 16, the computer readable program code comprising instructions for execution by the processor that cause the processor to:
rank the subset energy blocks as a function of average offer prices determined for each of the different subset energy blocks;
identify a combination of multiples of the subset energy blocks that is likely to provide a minimum offer price as a function of the combination subset block sizes and their respective average bidding history prices; and
allocate the energy bids according to the identified combination of multiples of the subset energy blocks.

18. The computer program product of claim 16, the computer readable program code comprising instructions for execution by the processor that cause the processor to:
identify a subset of the different energy suppliers that each meet boundary conditions of an allowable number of multiple bids for the quantity of energy; and
allocate the energy bids to the subset suppliers in amounts that meet the boundary conditions; and
wherein the boundary conditions award only one of the block sizes to a supplier from bids of the supplier, and enable the award of multiple bids to the awarded block size to the supplier.

19. The computer program product of claim 16, the computer readable program code comprising instructions for execution by the processor that cause the processor to determine the threshold dispersion value as a function of historic bidding data by at least one of the different energy suppliers.

20. The computer program product of claim 16, the computer readable program code comprising instructions for execution by the processor that cause the processor to determine the threshold dispersion value as a standard deviation value.
